(19) United States
(12) Patent Application Publication
(10) Pub. No.: US 2004/0164568 A1
(43) Pub. Date: Aug. 26, 2004

(54) Pet waste disposal system

(76) Inventor: Russel S. Diehl, San Bernardino, CA (US)

Correspondence Address: Ruth Eure, 4795 Edison Avenue, Boulder, CO, 80301, US

(21) Appl. No.: 10/373,308

(22) Filed: Feb. 24, 2003

(51) Int. Cl. A01K 29/00; E01H 1/12

(52) U.S. Cl. 294/1.4

(57) ABSTRACT

A system for collecting animal waste comprising a device for collecting animal waste, comprising an elongate handle, a receptacle for receiving waste, means for attaching the receptacle to the handle, said receptacle having a flattened bottom portion having a plurality of holes, and a plurality of spaced apart uniformly bent tines on one end, a plurality of spaced apart flat tines on the opposite end, and a removable back stop; and a caddy for holding the device for collecting animal waste further comprising; an upright support member having a loop for holding the device, a holder for a bottle, a hook for holding a supply of bags and a cleaning receptacle with a closable lid.

### FIELD OF THE INVENTION

This invention relates to the field of animal waste disposal.

### BACKGROUND OF THE INVENTION

For hundreds, if not thousands of years mankind has gained great benefit from the companionship and devotion of canines. Concomitant with the increase of human population in urban areas is the rise of canine population in urban areas. Since it is difficult to train the typical modern dog to use indoor plumbing facilities, the need has arisen for an efficient pet waste disposal device.

In response to this need, several designs have been put forth. Among these designs is U.S. Pat. No. 6,012,748 to Franks. This device provides a scoop having an elongate handle and an angled shovel portion. This device requires the user to bend and scoop the animal waste onto a receiving area for collection.

The art also provides U.S. Pat. No. 5,868,447 to Clark which provides an elongate handle portion, but is deficient in many of the other features of the present invention such as the removable back stop on the dual sided receptacle portion of the present invention which provides versatility to the present invention.

### SUMMARY OF THE INVENTION

The present invention provides improvements over these previous designs by providing a system for disposing of pet waste which comprises an implement having an elongate adjustable length handle having a handgrip at one end and terminating in a waste disposal device at the opposite end. The length of the elongated handle is adjusted so as to permit the device to be used by a human without bending over. The pet waste disposal device comprises an essentially rectangular receptacle having an open end to receive the pet waste. The device also has a removable back stop for preventing the waste from falling out of the receptacle when picking up multiple piles of waste.

Alternatively, the back stop can be removed from the device to comprise a rectangular receptacle having an opening at one end to receive the pet waste and an opening at the other end to receive a plastic bag which can be removably attached thereto. The plastic bag receives the pet waste and can then be removed from the device fot disposal.

In addition to the pet waste disposal device is a caddy which is adapted for a variety of functions. The caddy serves as an implement holder when attaching a new bag, a holder of a supply of bags, stowage of the implement when not in use and also a sanitizing receptacle.

The handle can be of adjustable length for ergonomic advantage to accommodate users of various heights.

One point of novelty of the present invention resides in its versatility. With the back stop removed, a disposable bag can be attached to either end. The device can be used to efficiently remove waste from grassy areas and hard surfaces by using the side of the device having tines tilted upward as the intake end and attaching a disposable bag to the opposite end, namely the side with the flat tines. The long tilted tines allow for a convenient angle to drag or pull the device along the ground in a combing and lifting action without the necessity of bending over by the user. Also, the device can be used to remove waste from very difficult grassy or uneven surfaces by pulling or dragging along the ground using the end with the tines bent upward as the intake end and attaching a disposable bag to the opposite end. Also, the short, flat tines are used for raking and gathering in grass and dirt areas.

The system of the present invention is suitable for the “backyard dog” where the animal or animals are confined to a specific area and where the animal waste accumulates for periodic clean up. The present invention provides a complete system for such a situation in that it provides a device for actual pick-up of the waste in a variety of environments, collection of waste, sanitization of the device after clean up is accomplished and stowage of the device for future use. None of the prior art devices offer a complete system for animal clean-up.

One of the most difficult areas to collect dog waste is in grassy areas. Dog waste can be at any depth in the grass and of any consistency, from hard to soupy. The device of the present invention addresses all of these problems effectively and maintains a clean and healthy environment. The device can be easily used with one hand, leaving the other hand free to carry a water hose, bag, bag holder, or any other container of choice.

In summary, the elongated handle is adjustable in length for easy handling. The long, bent pick-up tines can be adjusted to any depth in the grass by raising or lowering the elongated handle. The dog waste pick-up tray or receptacle of the device can be used with a plastic back-stop, which can be attached in two places in the tray; one for exposing the short tines, if desired, the other to increase the capacity of the pick-up tray. When the back stop is used in the pick-up tray, it has a limited waste capacity, usually three or four piles, depending on size. In this configuration, using a shopping bag holder or container of choice is preferred. When the device is used with an 8×12 inch plastic bag, the backstop is removed from the pick-up tray and the bag is attached and secured to the opposite end of the long bent tines with a rubber band. When the bag is full, it is gently pulled from the tray and the rubber band is used to secure the bag closed.

When using the bent tines to pick up dog waste in grass areas, the elongated handle is held at approximately a 70° angle, the angled tip ends of the tines are placed on the ground near the dog waste and the device is pulled toward the waste laying on top of the grass blades. The long tines are pulled under the waste in a combing and lifting action to lift the waste onto onto the flat center section of the tray. This action is continued until all waste is collected or the tray is full. Rotating the device will cause waste to fall against the backstop section of the tray or into the plastic bag if used.

If waste is deeper in the grass and not on the surface, the handle is raised or lowered to adjust the depth for proper pick up. When a soupy dog waste is addressed, a water hose is used to wash waste into soil, larger pieces are broken up by the bottom section with holes for mashing and short tines are used to comb and clean the grass. Any remaining pieces of waste can be picked up with short tines.

### BRIEF DESCRIPTION OF THE DRAWINGS

FIG. 1 is a perspective view of the preferred embodiment of the present invention.

FIG. 2 is a top view of the receptacle portion of the preferred embodiment of the present invention with the back stop in position with the handle removed.

FIG. 3 is a side view of the preferred embodiment of the present invention with the back stop in position.

FIG. 4 is a perspective view of the preferred embodiment of the present invention with the back stop removed.

FIG. 5 is a top view of the receptacle portion of the preferred embodiment of the present invention with the back stop removed.

FIG. 6 is a side view of the preferred embodiment of the present invention with the back stop removed.

FIG. 7 is a perspective view of the preferred embodiment of the present invention with a bag attached.

FIG. 8 is a perspective view of the caddy of the present invention showing the animal waste disposal device in its stowed position, bag storage device, sanitizing solution holder and sanitizing receptacle with the lid closed.

FIG. 9 is a perspective view of the caddy of the present invention with the lid open to show the receptacle for receiving sanitizing solution for cleaning the animal waste disposal device FIG. 10 is a front perspective view of the bag holder for holding open the bag for receiving waste.

FIG. 11 is a front perspective view of the bag holder with no bag in place.

### DETAILED DESCRIPTION OF THE INVENTION

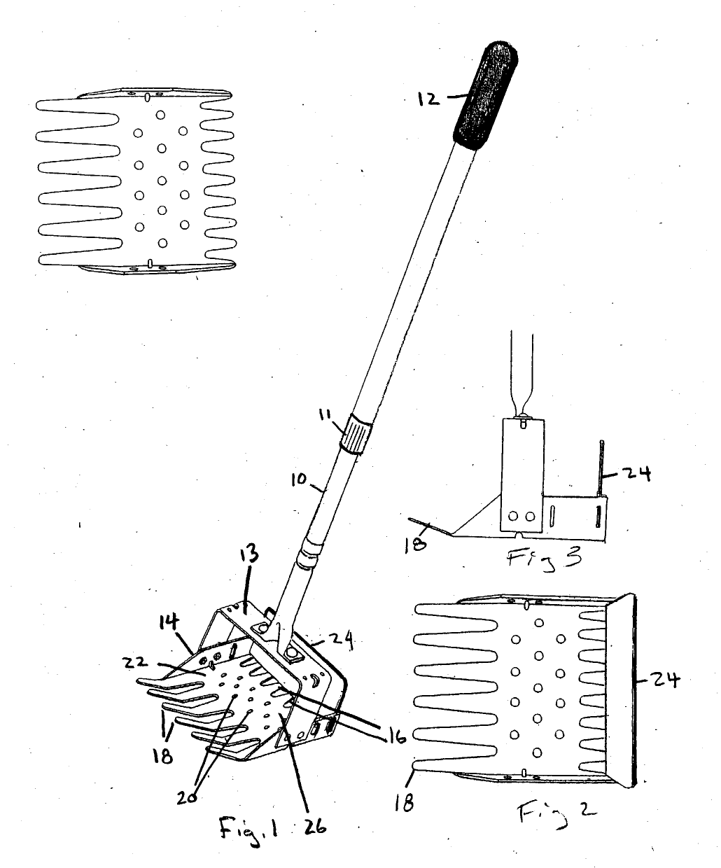

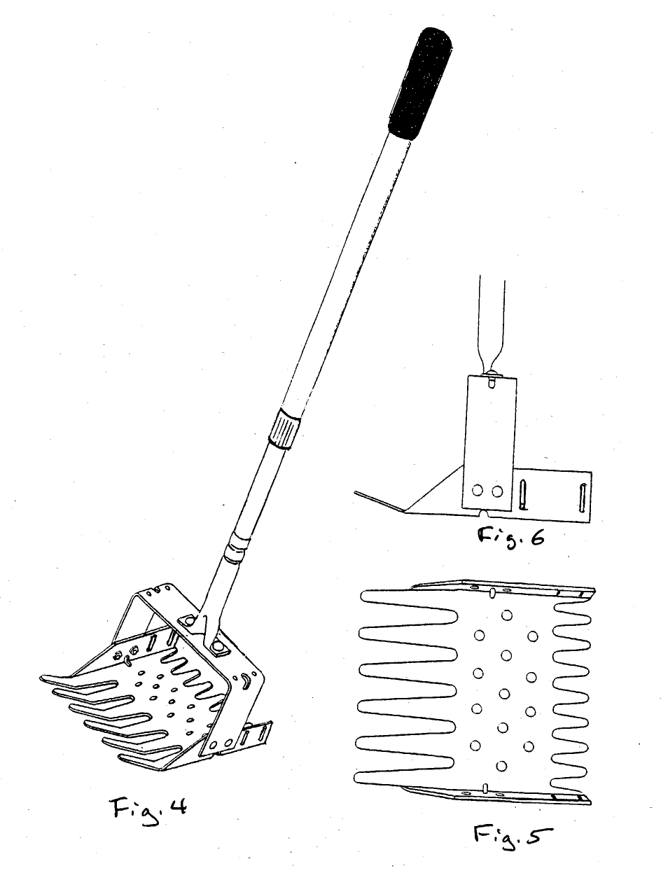

FIG. 1 shows elongate handle 10 which terminates at one end in a handle grip 12 and is adjustable using handle length adjusting collar 11. The length of the handle is adjustable by rotating handle length adjusting collar 11 counterclockwise to loosen the telescoping handle, adjusting to desired length, and then rotating handle length adjusting collar clockwise until tight. The opposite end of elongate handle 10 is attached to the center of handle U-shaped support member 13. U-shaped handle support member 13 is attached to the sides of waste disposal device 14, as shown in FIG. 1. Waste disposal device 14 has a bottom portion comprising a set of flat tines 16 at one end and bent tines 18 at the opposite end. Holes 20 are provided in the flattened center portion 22 of the device 14 for mashing waste when the device is used in conjunction with a garden hose or other water supply for washing soupy waste into the grassy soil. These features are also shown in FIG. 2. In FIGS. 1-3, backstop 24 is in place to prevent waste from falling out of the receptacle 26.

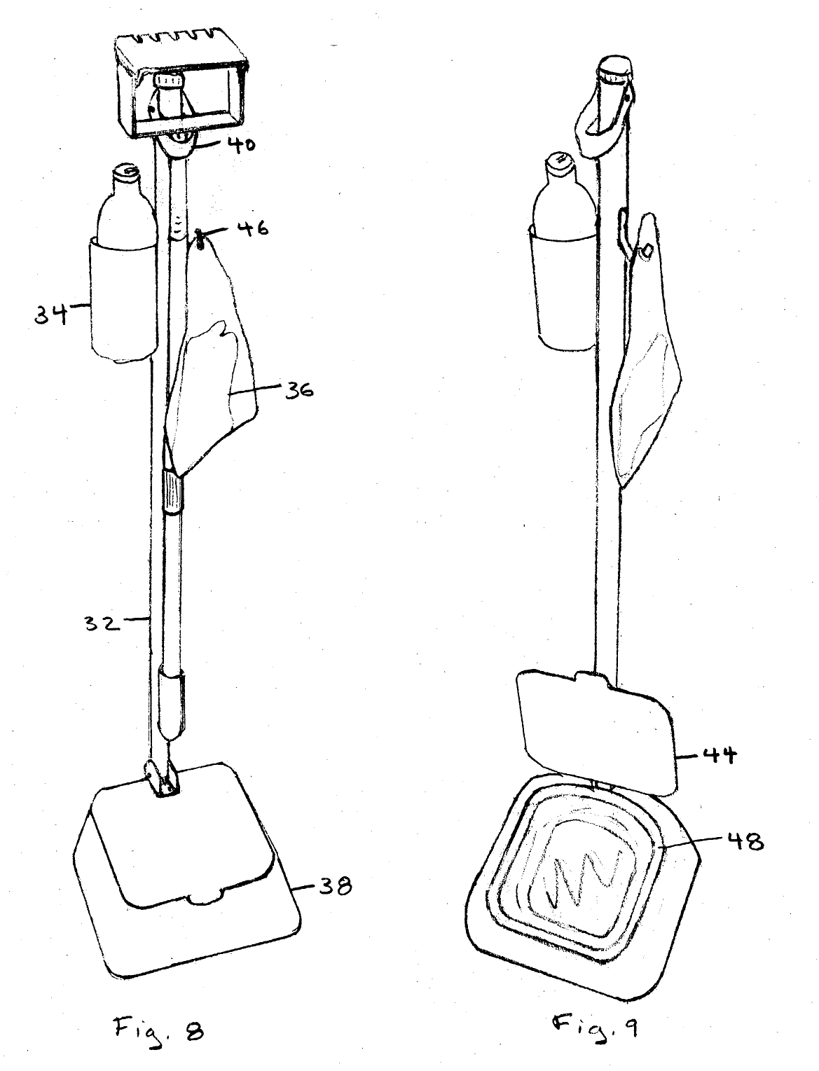

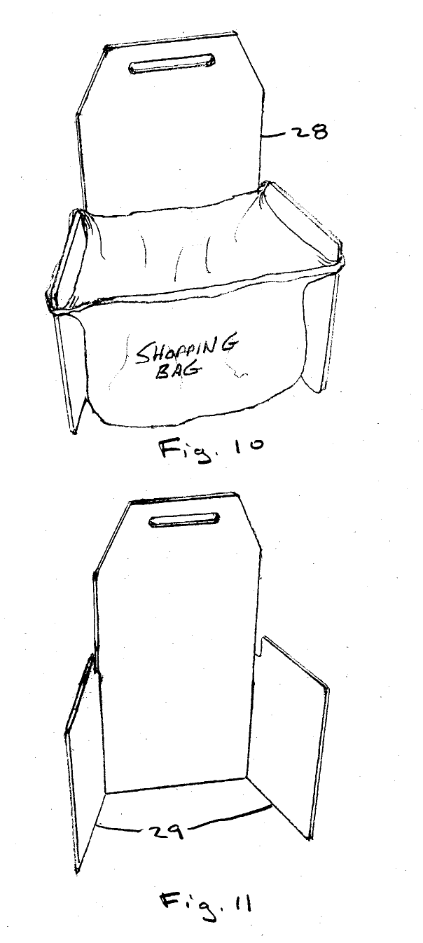

In operation, the device is held at the hand grip 12, and the bent tines are placed on the ground near the animal waste. The device can approach the waste from any angle. The device is dragged, or pulled along the ground under the waste thereby scooping the waste onto the flattened center portion 22. The device can be equipped with a bag as shown in FIG. 7 for receiving the waste. If no bag is attached to the device, back stop 24 can be put into place and a shopping bag can be attached to the bag holder 28 on the caddy 30 to receive the waste. This is shown in FIGS. 8 and 9. The bag holder is shown in FIGS. 10 and 11.

When retrieving accumulated waste the device is equipped with a back stop 24 for preventing the waste from falling out the back. Tines 18 are placed along the ground or hard surface adjacent the animal waste and as the device is dragged or pulled along the ground, the waste is recovered in the receptacle portion 26. The waste is then discarded. The waste can be discarded into any receptacle suitable for this purpose, but bag holder 28 is suitable for this purpose.

FIG. 7 shows a device having a bag 44 attached for easy clean-up of a small amount of animal waste. The bag 44 used for this purpose is suited for pet pick-up and is approximately 8 inches by 12 inches and is available in many pet supply stores. Any bag which fits onto the device can be used. A wire bag support 42 can also be used when attaching bag 44 to the device to hold the bag 44 off of the ground for receiving animal waste. Bag 44 can be attached to the device by slipping bag 44 over wire bag support 42 onto the body of the device and slipping a rubber band over the bag to hold it onto the device. When the bag is full, or is otherwise to be removed from the device, simply pull the bag off of the device and the rubber band is used for closing the bag and will hold its contents securely inside without undue handling on the part of the user.

FIG. 8 shows the caddy 30 which comprises an upright support member 32 which comprises a loop 40 for holding the device and a holder 34 for holding a bottle of sanitizing solution, and a cleaning receptacle 38 for cleaning the device. Caddy 30 also comprises a hook 46 to hold a supply of bags 36. Bag holder 28 can be seen in FIGS. 10 and 11. Bag holder 28 is a tripartite folded device used for holding open a bag such as is commonly available for carrying groceries. This shopping bag holder is for receiving pet waste when the device is used to clean up a yard or other area having multiple piles of animal waste. Flaps 29 fold out to receive the handles of shopping bag.

When clean up of animal waste has been completed, the device can be cleaned and sanitized in the caddy. Simply pour sanitizing solution into the bowl 42 contained in receptacle 38 shown in FIG. 9 and place the soiled device into the solution. After a few minutes, remove the device and stow it into loop 40 of the caddy and remove bowl 48 to discard the soiled solution. Replace bowl 48 into receptacle 38 and the caddy is ready for next use.

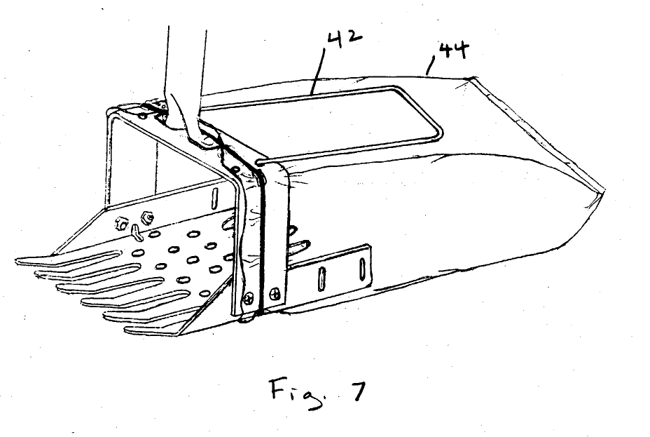

In summary, the pet waste disposal system provided by the instant invention provides a novel device which can be adjusted to provide a suitable animal waste clean-up device in a wide variety of situations. The primary device is shown in FIGS. 1-6 and can be used with the back stop for preventing waste from falling to the ground or with either end as the intake end with or without a bag attached. This device is intended for use with a receptacle such as is provided by the caddy described below.

The system of the present invention also provides a caddy for storing and carrying the device and holding the device in place for bag attachment. The caddy also holds supplies needed for animal clean-up; namely, small bags for attaching to the device for small clean-up, large bags for cleaning large areas, a hook for holding the bags, a holder for holding a bottle of sanitizing solution, and a receptacle for cleaning the device.

Although this invention has been described with respect to specific embodiments, it is not intended to be limited thereto and various modifications which will become apparent to the person of ordinary skill in the art are intended to fall within the spirit and scope of the invention as described herein taken in conj unction with the accompanying drawings and the appended claims.

1. A device for collecting animal waste, comprising an elongate handle, a receptacle for receiving waste, means for attaching the receptacle to the handle, said receptacle having a bottom portion forming a tray and a plurality of spaced apart uniformly bent tines on one end, and a plurality of spaced apart flat tines on the opposite end.

2. The device of claim 1 wherein the bottom portion is substantially flattened.

3. The device of claim 2 wherein bottom portion has a plurality of holes.

4. The device of claim 1 further comprising a removable back stop.

5. The device of claim 3 further comprising a removable back stop.

6. Tne device of claim 1 wherein the bent tines are bent at approximately 20 degrees from horizontal.

7. The device of claim 1 wherein the lengtn of the handle is adjustable.

8. The device of claim 1 wherein the receptacle can receive a bag holder on either side.

9. The device of claim 1 further comprising a caddy.

10. The device of claim 8 wherein the caddy for holding a device for collecting animal waste comprises; an upright support member having a loop for holding the device, a holder for a bottle, a hook for holding a supply of bags and a cleaning receptacle with a closable lid.

11. The device of claim 3 further comprising a caddy.

12. The device of claim 11 wherein the caddy comprises: an upright support member having a loop for holding the device, a holder for a bottle, a hook for holding a supply of bags and a cleaning receptacle with a closable lid.

13. The device of claim 4 further comprising a caddy.

14. The device of claim 13 wherein the caddy comprises; an upright support member having a loop for holding the device, a holder for a bottle, a hook for holding a supply of bags and a cleaning receptacle with a closable lid.

15. The device of claim 2 further comprising a back stop.

16. The device of claim 14 further comprising a caddy.

17. The device of claim 16 wherein the caddy comprises: an upright support member having a loop for holding the device, a holder for a bottle, a hook for holding a supply of bags and a cleaning receptacle with a closable lid.

18. A method of disposing of animal waste using the device of claim 8 comprising:
1) attaching a bag to to the end of the device having a plurality of spaced apart flat tines;
2) holding the elongate handle at approximately a 70° angle from horizontal;
3) placing the plurality of spaced apart uniformly bent tiles on the ground near the animal waste;
4) pulling the device toward the waste;
5) continuing pulling the plurality of spaced apart uniformly bent tines under the waste in a combing and lifting motion;
6) lifting the waste onto the flat center section of the tray;
7) rotating the tray causing the waste to fall into the bag;
8) repcating steps 3 through 7 until all waste is collected or the bag is full;
9) removing the bag from the device;
10) disposing of the bag.

19. A method of disposing of animal waste using the device of claim 5 comprising:
1) holding the clongate handle at approximately 70° angle from horizontal;
2) placing the plurality of spaced apart uniformly bent tines on the ground near the animal waste;
3) pulling the device toward the waste;
4) continuing pulling the plurality of spaced apart uniformly bent tines under the waste in a combing and lifting motion;
5) lifting the wasteonto the flat center section of the tray;
6) rotating the tray causing the waste to fall against the back stop;
6) repeating steps 3 through 5 until all waste is collected or the tray is full;
7) disposing of waste into a bag or other container.
